(19) United States
(12) Patent Application Publication
(10) Pub. No.: US 2012/0228292 A1
(43) Pub. Date: Sep. 13, 2012

(54) MOUNT FOR INLET CHECK VALVE

(75) Inventors: Cory J. Doble, West Harrison, IN (US); Paul C. Wetzel, Oxford, OH (US); Jason M. Crawford, Connersville, IN (US)

(73) Assignee: STANT USA CORP., Connersville, IN (US)

(21) Appl. No.: 13/414,256

(22) Filed: Mar. 7, 2012

Related U.S. Application Data
(60) Provisional application No. 61/451,444, filed on Mar. 10, 2011.

(51) Int. Cl. B60K 15/04; B23P 11/00; B21D 53/88; F16K 51/00; B60K 15/07; B60K 15/073

(52) U.S. Cl. 220/86.2; 141/349; 220/562; 29/897.2; 137/15.18; 29/505; 29/516

(57) ABSTRACT

A fuel system includes a fuel tank filler neck associated with a fuel tank. The fuel tank filler neck includes a fill tube for receiving a fuel-dispensing pump nozzle and a fuel conductor interconnecting an interior region of the fuel tank and a passageway formed in the fill tube.

### PRIORITY CLAIM

This application claims priority under 35 U.S.C. §119(e) to U.S. Provisional Application Ser. No. 61/451,444, filed Mar. 10, 2011, which is expressly incorporated by reference herein.

### BACKGROUND

The present disclosure relates to a fuel system, and particularly to a fuel-delivery control system. More particularly, the present disclosure relates to a fuel tank valve apparatus comprising a fuel tank filler neck and an inlet check valve for regulating flow of liquid fuel and fuel vapor through the fuel tank filler neck.

A filler neck conducts liquid fuel from a fuel-dispensing pump nozzle to an interior fuel-storage region in a fuel tank. Although an opened passageway through the filler neck into the fuel tank is needed during refueling to conduct liquid fuel from the pump nozzle into the fuel tank, it is desirable to close the filler neck at other times to block discharge of liquid fuel and fuel vapor from the fuel tank through the filler neck. In many cases, a fuel cap is mounted on an outer end of the filler neck to close the filler neck during the time period before and after each tank refueling activity.

### SUMMARY

According to the present disclosure, a fuel system comprises a fuel tank filler neck including a fuel conductor that is adapted to extend into an interior fuel-storage region of a fuel tank through an inlet aperture formed in the fuel tank. The fuel conductor includes a tubular housing and an inlet check valve apparatus.

In illustrative embodiments, the tubular housing is formed to include a fuel-transfer channel arranged in illustrative embodiments to receive liquid fuel flowing through a fill tube also included in the fuel tank filler neck and coupled to the fuel conductor. The inlet check valve apparatus includes a valve that is mounted for movement relative to a downstream end of the tubular housing to open and close a downstream fuel-discharge aperture opening into the fuel-transfer channel and communicating with the interior fuel-storage region of the fuel tank.

In illustrative embodiments, the fuel conductor further includes a tank mount comprising a spud anchor and a separate spud configured to be fastened to the spud anchor and adapted to be coupled to a fuel tank and a fill tube associated with the fuel tank. The spud anchor is coupled to a middle portion of the tubular housing to lie in a stationary position on the tubular housing in an illustrative assembly and installation process in accordance with the present disclosure. The spud is configured to be fastened to the spud anchor and adapted to mate with the fuel tank and formed to include a central channel sized to receive an upstream end of the tubular housing therein.

The spud is mounted on an upstream end of the tubular housing and coupled to the spud anchor to lie in a fixed position on the upstream end of the tubular housing using an assembly process in accordance with the present disclosure. The spud is configured to (1) mate with the fuel tank to support the tubular housing in a proper stationary position in the inlet aperture formed in the fuel tank and (2) mate with a fill tube included in the filler neck.

In illustrative embodiments, the spud anchor is made, for example, of a weldable material such as high-density polyethylene (HDPE). The spud is also made of HDPE in an illustrative embodiment.

In an illustrative filler neck assembly and installation process, the spud anchor is overmolded onto a tubular housing made of polyoxymethylene (POM) to establish a mechanical joint and a fluid leak barrier between the tubular housing and the spud anchor. The inlet check valve apparatus is mounted on the downstream end of the tubular housing in close proximity to the inlet aperture formed in the fuel tank.

The spud is pressed onto the tubular housing to cause the upstream end of the tubular housing to pass through the central passage formed in the spud until the spud mates with the stationary spud anchor that has been overmolded onto the tubular housing. An interface between the spud and the spud anchor is welded to create a mechanical joint and a fluid leak barrier between the spud and the spud anchor.

The downstream end of the tubular housing carrying the inlet check valve apparatus is inserted into the interior fuel-storage region of the fuel tank through the inlet aperture formed in the fuel tank and moved in an inward direction until the spud mates with an exterior surface of the fuel tank. The spud is coupled to the fuel tank using any suitable means (e.g., welding) to retain the tubular housing in a fixed position relative to the fuel tank. The fill tube is coupled to the spud to cause a fuel-conducting passageway formed in the fill tube to lie in fluid communication with the fuel-transfer channel formed in the tubular housing.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of a vehicle fuel system having a filler neck coupled to the fuel tank and showing that the filler neck includes a fill tube and a fuel conductor in accordance with the present disclosure interposed between and coupled to the fuel tank and the fill tube;

FIG. 1A is a partial top view of the fuel tank, fuel conductor, and fill tube of FIG. 1;

FIG. 2 is an exploded perspective assembly view of a fuel conductor in accordance with the present disclosure showing, in series, from right to left, a spud, a tubular housing, a ring-shaped spud anchor overmolded onto a middle portion of the tubular housing and configured to cooperate with the spud to form a tank mount, and an inlet check valve apparatus comprising a flapper-door valve, a valve mover, and a valve-mover biasing spring;

FIG. 3 is a cross-sectional view of the fuel tank, fuel conduit, and filler neck of FIG. 1 showing the flapper-door valve in the closed position and suggesting that the tubular housing and the ring-shaped spud anchor (that has been overmolded onto the tubular housing) cooperate to form a valve carrier on which inlet check valve apparatus is mounted and that the spud is fastened (e.g., welded) to both of the spud anchor and the fuel tank to fix the tubular housing in a stationary position relative to the fuel tank and coupled to a downstream end of the fill tube of FIG. 1; and

FIG. 4 is a view similar to FIG. 3 showing the flapper-door valve in an opened position during refueling to allow liquid fuel flowing through the fill tube and the fuel conduit to flow into the interior fuel-storage region formed in the fuel tank.

### DETAILED DESCRIPTION

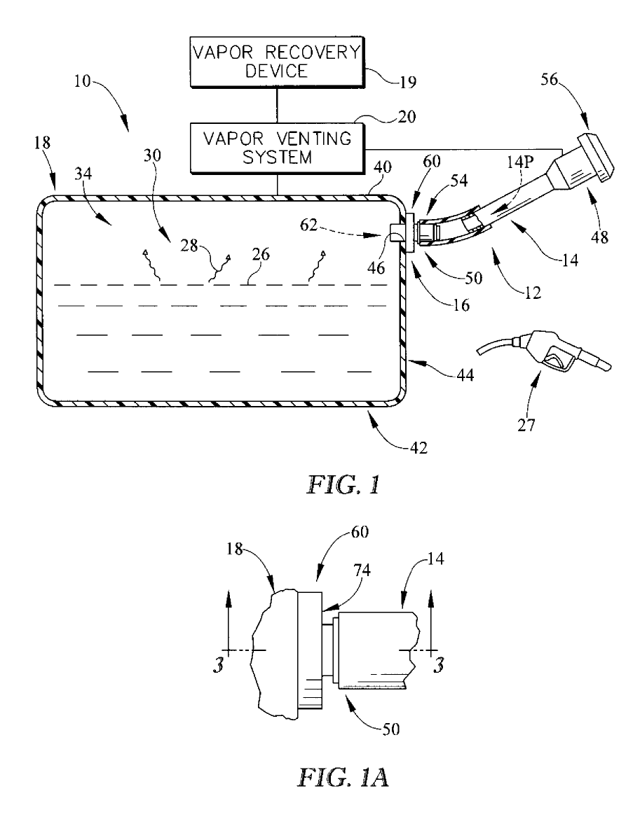

A fuel system 10 for use with a vehicle is shown in FIG. 1. Fuel system 10 includes a fuel tank 18, a vapor-venting system 20 coupled to fuel tank 18 and to a vapor-recovery device 19, and a filler neck 12. Filler neck 12 includes a fill tube 14 and a fuel conductor 16 coupled to fill tube 14 and to fuel tank 18 and to intercept and conduct liquid fuel flowing through fill tube 14 into fuel tank 18.

Fuel conductor 16 includes a tubular housing 70, an inlet check valve apparatus 62, and a tank mount 71 coupled to an exterior portion of tubular housing 70. Tank mount 71 is adapted to mate with and be fastened to an exterior surface of fuel tank 18 to support tubular housing 70 in a position extending into an interior fuel-storage region 30 formed in fuel tank 18 through an inlet aperture 46 formed in fuel tank 18 and locating inlet check valve apparatus 62 in fuel tank 18 near inlet aperture 46 as suggested in FIG. 1.

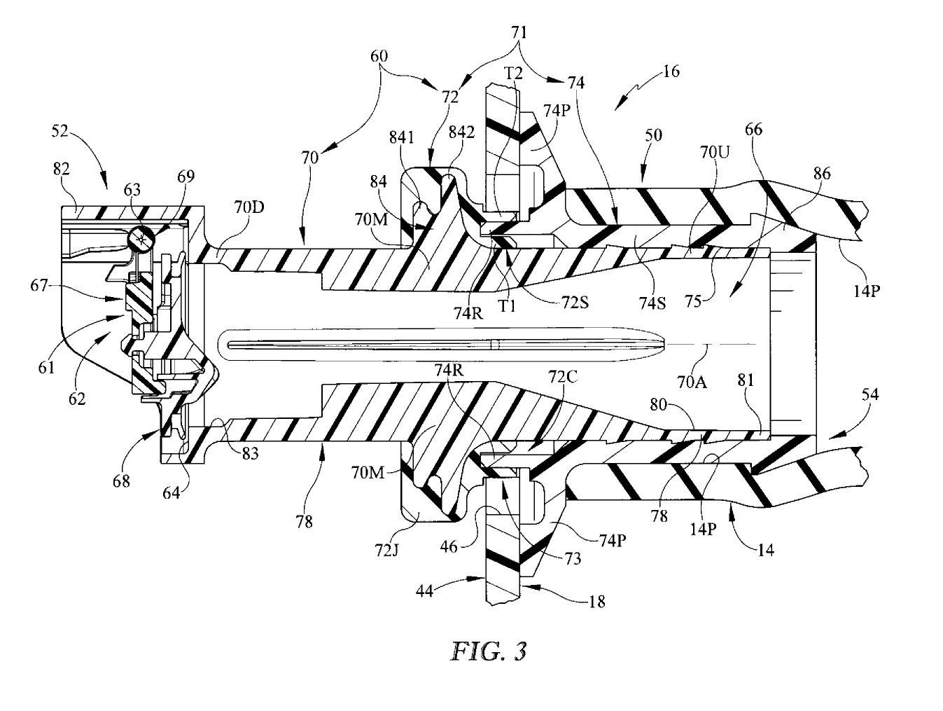

Tank mount 71 is made of a first plastics material that is weldable or otherwise easy to fasten to a fuel tank 18 made of the same or a similar plastics material. Tubular housing 70 is made of a different second plastics material such as an engineered structural material. An overmolding process in accordance with the present disclosure is used to couple tank mount 71 to tubular housing 70 as suggested in FIG. 3 before tank mount 71 is fastened to fuel tank 18.

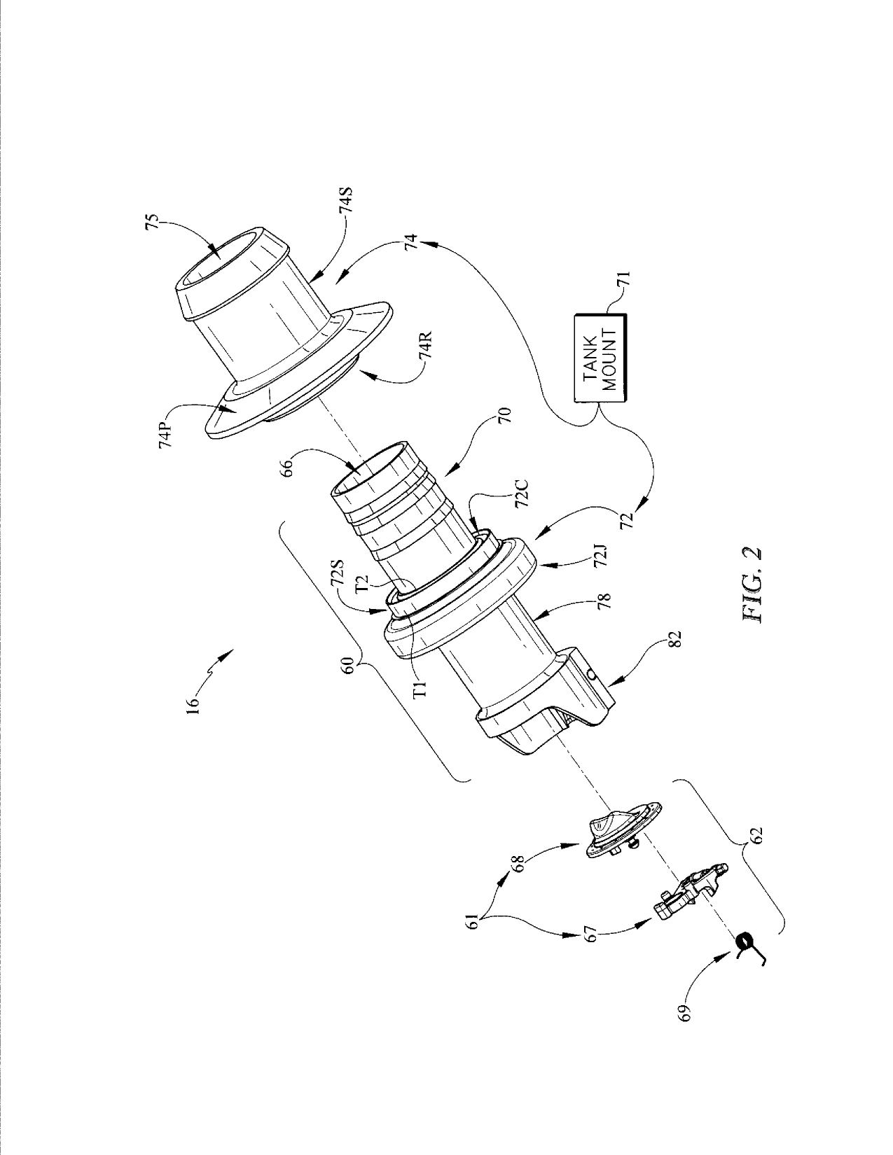

Tank mount 71 includes a ring-shaped spud anchor 72 that is made of the first plastics material and that is overmolded onto tubular housing 70 to mount spud anchor 72 in a stationary position on tubular housing 70 as suggested in FIG. 2. Tank mount 71 also includes a separate fill-tube connector spud 74 that is made of the first plastics material so that it is weldable or otherwise easy to fasten to spud anchor 72 and also to fuel tank 18 as suggested in FIG. 3. Fill-tube connector spud 74 is coupled to fill tube 14 and coupled to fuel tank 18 as suggested in FIG. 3

Fill tube 14 conducts liquid fuel 26 to fuel conductor 16 during tank refueling and fuel conductor 16 regulates the flow of liquid fuel 26 and fuel vapor 28 between fill tube 14 and an interior fuel-storage region 30 of fuel tank 18. Vapor venting system 20 regulates venting of fuel vapor 28 extant in a vapor space 34 in interior fuel-storage region 30 of fuel tank 18 to vapor-recovery device 19 located outside of fuel tank 18.

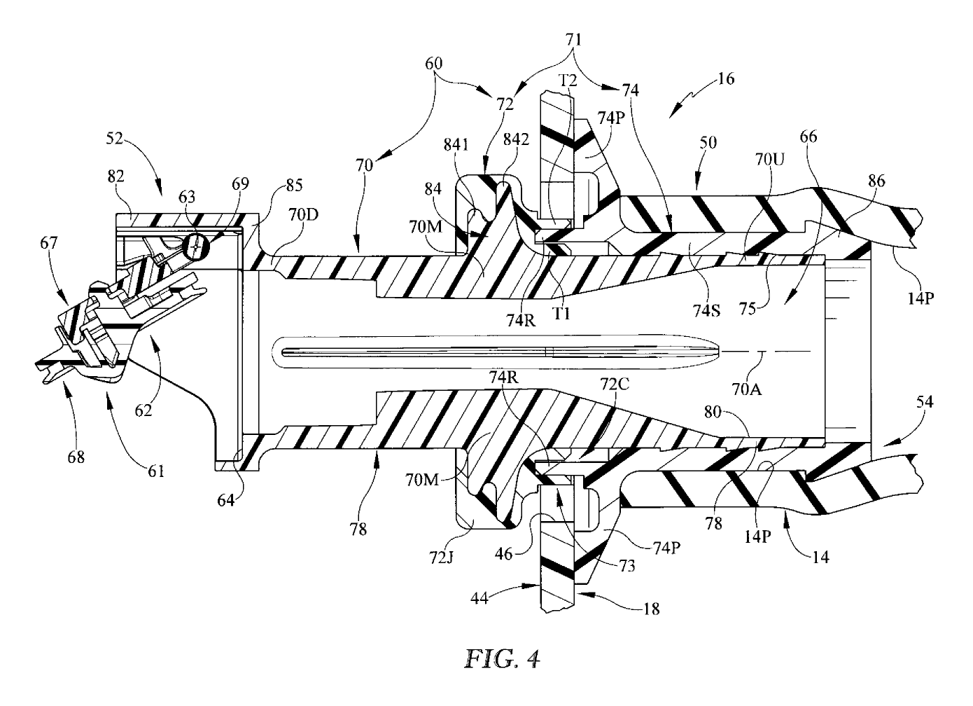

Fuel tank 18 includes a top wall 40, a bottom wall 42 spaced apart from top wall 40, and a side wall 44 formed to include an inlet aperture 46 as shown, for example, in FIG. 1. Fuel conductor 16 is mounted to side wall 44 and arranged to extend or be extended through inlet aperture 46 as shown in FIG. 1. Fill tube 14 includes a mouth 48 at an outer end and a discharge outlet 50 at an inner end. Fuel conductor 16 has an outer end 54 (defined by tank mount 74) coupled to discharge outlet 50 of filler neck 14 and an inner end 52 (defined by tubular housing 70) arranged to extend into interior fuel-storage region 30 of fuel tank 18. Inlet check valve apparatus 62 is mounted on inner end 52 of tubular housing 70 and includes a pivotable closure 61 as suggested in FIGS. 3 and 4. Mouth 48 is formed to receive a fuel-dispensing pump nozzle 27 during tank refueling and a closure 56 at all times other than refueling.

Fuel conductor 16 functions, for example, to conduct the flow of liquid fuel 26 into fuel tank 18 from fill tube 14 during tank refueling and to establish a barrier configured to block flow of liquid fuel and fuel vapor between fill tube 14 and fuel tank 18 at certain other times. Prior to refueling, fuel conductor 16 is configured to assume a closed state, as shown in FIG. 3. During refueling, fuel conductor 16 is configured to assume an opened state, as shown in FIG. 4, and conduct liquid fuel 26 dispensed into fill tube 14 into interior fuel-storage region 30 of fuel tank 18. After refueling, fuel conductor 16 is reconfigured to assume the closed state shown in FIG. 3.

In an illustrative embodiment shown in FIG. 2, fuel conductor 16 comprises a fill-tube connector spud 74 adapted to mate with side wall 44 of fuel tank 18, a tubular housing 70 arranged to extend into fuel tank 18, and a ring-shaped spud anchor 72 arranged to interconnect tubular housing 70 and fill-tube connector spud 74. Tubular housing 70 has an upstream end 70U sized to extend through a central channel 75 formed in fill-tube connector spud 74.

Ring-shaped spud anchor 72 has a jacket 72J that is overmolded onto a middle portion 70M of tubular housing 70 in an illustrative embodiment as suggested in FIGS. 2 and 3 so that spud anchor 72 can be fixed in a stationary position no tubular housing 70 even though it is made of a plastics material that is different from the plastics material used to make tubular housing 70. An anchor retainer 84 is included in tubular housing 70 and mated with jacket 72J of spud anchor 72 during the anchor overmolding process. In illustrative embodiments, one or more lobes such as lobes 841, 842 of any suitable size, shape, and spacing cooperate to define anchor retainer 84 as suggested in FIG. 3.

Tubular housing 70 and spud anchor 72 when joined together cooperate to form a valve carrier 60 as suggested in FIG. 2. An inlet check valve apparatus 62 also included in fuel conductor 16 is mounted on tubular housing 70 of valve carrier 60 as suggested in FIGS. 2 and 3.

Inlet check valve apparatus 62 comprises a flapper-door valve 68, a valve mover 67, and a valve-mover biasing spring 69 in an illustrative embodiment as suggested in FIG. 2. Inlet check valve apparatus 62 is coupled to tubular housing 70 included in valve carrier 60 as suggested in FIG. 3. It is within the scope of the present disclosure to use any suitable inlet check valve apparatus on valve carrier 60.

Fuel conductor 16 is adapted to extend into an interior fuel-storage region 30 of a fuel tank 18 through an inlet aperture 46 formed in fuel tank 18. Fuel conductor 16 includes a tubular housing 70 formed to include a fuel-transfer channel 66 and an inlet check valve apparatus 62 including a closure 61 that is mounted for movement relative to a downstream end 70D of tubular housing 70 to open and close a downstream fuel-discharge aperture opening into fuel-transfer channel 66 and communicating with interior fuel-storage region 30 of fuel tank 18 as suggested in FIGS. 3 and 4.

Tank mount 71 comprises a stationary spud anchor 72 coupled to a middle portion 70M of tubular housing 70 and a fill-tube connector spud 74 adapted to mate with fuel tank 18 and formed to include a central channel 75 sized to receive an upstream end 70U of tubular housing 70 therein. In an illustrative embodiment, a multi-lobe anchor retainer 84 located at middle portion 70M of tubular housing 70 is configured to extend radially outwardly away from a central axis 70A of tubular housing 70 and be covered by and mate with spud anchor 72 as suggested in FIG. 3. Fill-tube spud 74 is mounted on an upstream end 70U of tubular housing 70 and coupled to spud anchor 72 at interface 73 to lie at interface 73 in a fixed position on the upstream end 70U of tubular housing 70 as suggested in FIG. 3. Fill-tube connector spud 74 is configured to mate with a fill tube 14 included in filler neck 12 as also suggested in FIG. 3.

In an illustrative assembly process, spud anchor 72 is made, for example, of a weldable plastics material such as high-density polyethylene (HDPE) and is overmolded onto a tubular housing 70 made of polyoxymethylene (POM) plastics material during a manufacturing process at a factory to establish a mechanical joint and a fluid leak barrier between tubular housing 70 and spud anchor 72. Fill-tube connector spud 74 is also made of HDPE in an illustrative embodiment and is compatible with and weldable to a fuel tank 18 made of HDPE.

Fill-tube connector spud 74 is pressed onto tubular housing 70 at a later stage of the manufacturing process to cause the upstream end 70U of tubular housing 70 to pass through central channel 75 formed in fill-tube connector spud 74 until spud 74 mates with the stationary spud anchor 72 coupled to tubular housing 70. An interface 73 provided between fill-tube connector spud 74 and spud anchor 72 is welded to create a mechanical joint and a fluid leak barrier between fill tube connector spud 74 and spud anchor 72.

Downstream end 70D of tubular housing 70 carrying inlet check valve apparatus 62 is inserted into interior fuel-storage region 30 of fuel tank 18 through inlet aperture 46 formed in fuel tank 18. Fill-tube connector spud 74 is fastened to fuel tank 18 using any suitable means (e.g., welding) to retain tubular housing 70 in a fixed position relative to fuel tank 18. Fill tube 14 is coupled to fill-tube connector spud 74 to cause a fuel-conducting passageway formed in fill tube 14 to lie in fluid communication with fuel-transfer channel 66 formed in tubular housing 70 and arranged to communicate with interior fuel-storage region 30 formed in fuel tank 18 when flapper-door valve 68 of inlet check valve apparatus 62 is in the opened position. In an illustrative embodiment, fill-tube connector spud 74 has a multilayer construction and comprises an EVOH center layer and an HDPE outer layer.

Fuel conductor 16 includes a valve carrier 60 comprising tubular housing 70 and a spud anchor 72 coupled to tubular housing 70 and an inlet check valve apparatus 62 as suggested in FIGS. 2 and 3. Inlet check valve apparatus 62 is coupled to valve carrier 60 and includes a closure 61 that is mounted for pivotable movement between a closed position shown in FIG. 3 and an opened position shown in FIG. 4. In the closed position, fuel and fuel vapor are not allowed to flow between fuel tank 18 and fill tube 14 through fuel conductor 16. However, in the opened position, fuel and fuel vapor are allowed to flow through fuel conductor 16.

Tubular housing 70 included in valve carrier 60 is formed to include a valve seat 64 and a fuel-transfer channel 66 terminating at the valve seat 64 as shown, for example, in FIG. 3. Valve carrier 60 is adapted to be coupled to fill tube 14 and fuel tank 18 as suggested in FIGS. 1, 3, and 4 to conduct fuel from fill tube 14 to fuel tank 18 through fuel-transfer channel 66 during vehicle refueling. Closure 61 of check valve apparatus 62 is pivotable about a pivot axis 63 (see FIG. 4) relative to tubular housing 70 of valve carrier 60 to the closed position as shown in FIG. 3 to engage valve seat 64 to block discharge of fuel from fuel-transfer channel 66 of fuel conductor 16 into fuel tank 18. Closure 61 of inlet check valve apparatus 62 can also pivot about pivot axis 63 to the opened position as shown in FIG. 4 to disengage valve seat 64 to allow discharge of fuel from fuel-transfer channel 66 of fuel conductor 16 into fuel tank 18.

Tank inlet check valve apparatus 62 comprises a flapper-door valve 68, a valve mover 67, and a valve-mover biasing spring 69 as shown, for example, in FIGS. 2-4. Valve mover 67 and flapper-door valve 68 cooperate to define a closer 61. Flapper-door valve 68 is configured to mate with valve seat 64 provided in tubular housing 70 of valve carrier 60. Valve mover 67 is pivotably coupled to tubular housing 70 of valve carrier 60 at pivot axis 63 to carry flapper-door valve 68 toward and away from valve seat 64. Valve-mover biasing spring 69 yieldably urges valve mover 67 so as to bias flapper-door valve 68 normally to the closed position shown in FIG. 4. In an illustrative embodiment, flapper-door valve 68 includes an annular sealing gasket made of a fluorosilicone material overmolded onto a valve plate made of a nylon material. Valve-mover biasing spring 69 is a torsion spring made of a stainless steel material. Valve mover 67 is made of a polyoxymethylene (POM) material in an illustrative embodiment.

In the illustrated embodiment, valve carrier 60 includes a tubular housing 70 and a spud anchor 72 overmolded onto tubular housing 70 in the manner suggested in FIGS. 2 and 3. Tubular housing 70 is made, for example, of polyoxymethylene (POM). Spud anchor 72 is made of a weldable material such as, for example, high-density polyethylene so that it can be welded to a fill-tube connector spud 74 also made of a weldable HDPE that can be welded to spud anchor 72 and to fuel tank 18 to support tubular housing 70 in a fixed position in inlet aperture 46 formed in fuel tank side wall 44. Closure 61 of inlet check valve apparatus 62 is coupled to tubular housing 70 for pivotable movement about pivot axis 63 in the illustrated embodiment. Valve mover 67 of closure 61 is designed to be snap-fit to valve carrier 60 in an illustrative embodiment and is made of the same plastics material as tubular housing 70.

Tubular housing 70 includes a pipe 78 having a cylindrical interior wall 80 defining a boundary of fuel-transfer channel 66 as shown, for example, in FIG. 3. One end 81 of pipe 78 is open to receive fuel from a fuel-conducting passageway formed in fill tube 14. Valve seat 64 is formed at an opposite downstream end 83 of pipe 78 to define an opening through which fuel is discharged from fuel-transfer channel 66 into interior fuel-storage region 30 of fuel tank 18 when closure 61 of inlet check valve apparatus 62 is moved to the opened position as shown, for example, in FIG. 4.

Tubular housing 70 also includes an outer sleeve 82 configured to surround a downstream portion of pipe 78, which portion is formed to include valve seat 64, as shown, for example, in FIG. 3. Tubular housing 70 further includes a radially outwardly extending annular anchor retainer 84 coupled to an exterior surface of pipe 78 at middle portion 70M of tubular housing 70 and arranged to mate with spud anchor 72 during the overmolding process.

Spud anchor 72 includes a jacket 72J coupled to pipe anchor 84 and an annular sleeve 72S coupled to jacket 72J and arranged to surround pipe 78 and extend toward upstream end 70U of tubular housing 70. Annular sleeve 72S is formed to include an annular rim-receiving channel 72C and fill-tube connector spud 74 includes a cylindrical rim 74R that extends into that rim-receiving channel 72C as suggested in FIGS. 3-5. Rim 74R is welded to annular sleeve 72S in illustrative embodiments.

Outer sleeve 82 includes a proximal end coupled to pipe 78 to retain sleeve 82 in a cantilevered position relative to valve seat 64 as suggested in FIG. 3. A ramped collar 86 forming a sealing barb is formed on an upstream end of fill-tube connector spud 74 as shown in FIG. 3 for expanding fill tube 14 radially outwardly as fill tube 14 is coupled to fill tube connector spud 74.

A process of assembling a portion of a fuel tank filler neck 12 comprises the steps of providing a tubular housing 70 formed to include a fuel-transfer channel 66 extending from an upstream end 70U thereof to downstream end 70D thereof, mounting an inlet check valve apparatus 62 on a downstream end 70D of tubular housing 70D to regulate flow of liquid fuel 26 and fuel vapor 28 through an outlet formed in tubular housing 70 to open into fuel transfer channel 66, and overmolding a ring-shaped spud anchor 72 onto an exterior portion of tubular housing 70 to locate the ring-shaped spud anchor 72 in a stationary position on tubular housing 70 as suggested in FIGS. 2 and 3. In illustrative embodiments, the process further comprises the step of coupling a spud 74 to the ring-shaped spud anchor 72 to form a tank mount 71 configured to provide means for mating with a fuel tank 18 to support tubular housing 70 in an aperture 46 formed in fuel tank 18 to position downstream end 70D of tubular housing 70 in communication with an interior fuel-storage region 30 formed in fuel tank 18 and to position outlet end 70U of tubular housing 70 outside of fuel tank 18 to communicate with a fill tube 14 associated with fuel tank 18 as suggested in FIGS. 2 and 3.

Tubular housing 70 includes a pipe 78 formed to include fuel-transfer channel 66 and a radially outwardly extending anchor retainer 84 as suggested in FIG. 3. Anchor retainer 84 is coupled to an exterior portion of pipe 78 and embedded in spud anchor 72 during the overmolding step to retain spud anchor 72 in the stationary position on tubular housing 70 as suggested in FIGS. 3 and 4.

Anchor retainer 84 includes a radially outwardly extending first lobe 841 located between upstream and downstream ends 70U, 70D of tubular housing 70 and a radially outwardly extending second lobe 842 located between first lobe 841 and inlet end 70U as suggested in FIG. 3. It is within the scope of the present disclosure to provide a single lobe to define an anchor retainer or provide a series of circumferentially spaced-apart lobe sections that cooperate to act like a single lobe.

First lobe 841 is ring-shaped and has a first outer diameter as suggested in FIG. 3. Second lobe 842 is ring-shaped and has a second outer diameter that is greater than the first outer diameter as also suggested in FIG. 3. Each of first and second lobes 841, 842 is embedded in spud anchor 72 during an overmolding process as suggested in FIG. 3.

Spud anchor 72 includes an annular jacket 72J overmolded onto pipe 78 and to first and second lobes 841, 842 and a spud-retainer sleeve 72S coupled to the annular jacket 72J as suggested in FIG. 3. Spud-retainer sleeve 72S is arranged to extend along an exterior surface of pipe 78 in a direction toward upstream end 70U of tubular housing 70 and spud 74 is coupled to spud-retainer sleeve 72S as suggested in FIG. 3.

Annular jacket 72J is located in interior fuel-storage region 30 of fuel tank 18 as shown, for example, in FIG. 3. Spud-retainer sleeve 72S is arranged to extend through inlet aperture 46 formed in fuel tank 18 as shown, for example, in FIG. 3.

Spud-retainer sleeve 72S is formed to include a rim-receiving channel 72C as shown, for example, in FIG. 3. Spud 74 includes a rim 74R that is arranged to extend into rim-receiving channel 72C to couple spud 74 to spud anchor 72. Spud 74 further includes a tank-mount pad 74P arranged to surround rim 74R and mate with fuel tank 18 and a tank-mount shaft 74S arranged to extend along and around pipe 78 of tubular housing 10 and mate with fill tube 14. Rim 74R included in spud 74 has a cylindrical shape as suggested in FIGS. 2 and 3.

Spud-retainer sleeve 72S includes inner and outer cylinder-shaped tubes T1, T2 as suggested in FIG. 3 Inner cylinder-shaped tube T1 is cantilevered to annular jacket 72J and arranged to surround tubular housing 70. Outer cylinder-shaped tube T2 is cantilevered to annular jacket 72J and arranged to surround inner cylinder-shaped tube T1 to define rim-receiving channel 72C therebetween as suggested in FIG. 3. Rim 74R is cylinder-shaped and arranged to lie in rim-receiving channel 72C between inner and outer cylinder-shaped tubes T1, T2 of spud-retainer sleeve 72.

In an illustrative assembly and installation process, the coupling step comprises the steps of passing upstream end 70U of tubular housing 70 through a central channel 75 formed in spud 74 until spud 74 mates with spud anchor 72 and fastening spud anchor 72 to spud 74 to create a mechanical joint and a fluid-leak barrier between spud 74 and spud anchor 72 as suggested in FIGS. 2 and 3. The coupling step further comprises the steps of inserting downstream end 70D of tubular housing 70 carrying inlet check valve apparatus 62 into interior fuel-storage region 30 of fuel tank 18 through the inlet aperture 46 formed in fuel tank 18 and fastening spud 74 to fuel tank 18 to retain tubular housing 70 in a fixed position relative to fuel tank 18 as suggested in FIG. 3.

An illustrative assembly and installation process further comprises the step of coupling fill tube 14 to spud 74 to cause a fuel-conducting passageway 14P formed in fill tube 14 to lie in fluid communication with fuel-transfer channel 66 formed in tubular housing 70 as suggested in FIG. 3. Fuel-transfer channel 66 is arranged to communicate with interior fuel-storage region 30 in fuel tank 18 when a closure 61 included in inlet check valve apparatus 62 is moved relative to tubular housing 70 from a closed position blocking a downstream fuel-discharge aperture formed in downstream end 70D as suggested in FIG. 3 to an opened position opening the downstream fuel-discharge aperture formed in downstream end 70D as suggested in FIG. 4.

1. A process of assembling a portion of a fuel tank filler neck, the process comprising the steps of
providing a tubular housing formed to include a fuel-transfer channel extending from a downstream end thereof to an upstream end thereof,
mounting an inlet check valve apparatus on the downstream end of the tubular housing to regulate flow of liquid fuel and fuel vapor through an outlet formed in the tubular housing to open into the fuel-transfer channel,
overmolding a ring-shaped spud anchor onto an exterior portion of the tubular housing to locate the ring-shaped spud anchor in a stationary position on the tubular housing, and
coupling a spud to the ring-shaped spud anchor to form a tank mount configured to provide means for mating with a fuel tank to support the tubular housing in an aperture formed in the fuel tank to position the downstream end of the tubular housing in communication with an interior fuel-storage region formed in the fuel tank and to position the upstream end of the tubular housing outside of the fuel tank to communicate with a fill tube associated with the fuel tank.

2. The process of claim 1, wherein the tubular housing includes a pipe formed to include the fuel-transfer channel and a radially outwardly extending anchor retainer coupled to an exterior portion of the pipe and embedded in the spud anchor during the overmolding step to retain the spud anchor in the stationary position on the tubular housing.

3. The process of claim 2, wherein the anchor retainer includes a radially outwardly extending first lobe located between the upstream and downstream ends of the tubular housing and a radially outwardly extending second lobe located between the first lobe and the upstream end.

4. The process of claim 3, wherein the first lobe is ring-shaped and has a first outer diameter and the second lobe is ring-shaped and has a second outer diameter that is greater than the first outer diameter.

5. The process of claim 3, wherein the spud anchor includes an annular jacket overmolded onto the pipe and to the first and second lobes and a spud-retainer sleeve coupled to the annular jacket and arranged to extend along an exterior surface of the pipe in a direction toward the inlet end of the tubular housing and the spud is coupled to the spud-retainer sleeve.

6. The process of claim 5, wherein the annular jacket is located in the interior fuel-storage region of the fuel tank and the spud-retainer sleeve is arranged to extend through the inlet aperture formed in the fuel tank.

7. The process of claim 2, wherein the spud anchor includes an annular jacket overmolded onto the pipe and to the anchor retainer and a spud-retainer sleeve coupled to the annular jacket and arranged to extend along an exterior surface of the pipe in a direction toward the upstream end of the tubular housing and the spud is coupled to the spud-retainer sleeve.

8. The process of claim 7, wherein the annular jacket is located in the interior fuel-storage region of the fuel tank and the spud-retainer sleeve is arranged to extend through the inlet aperture formed in the fuel tank.

9. The process of claim 8, wherein the spud-retainer sleeve is formed to include a rim-receiving channel and the spud includes a rim that is arranged to extend into the rim-receiving channel to couple the spud to the spud anchor.

10. The process of claim 9, wherein the spud further includes a tank-mount pad arranged to surround the rim and mate with the fuel tank and a tank-mount shaft arranged to extend along and around the pipe of the tubular housing and mate with the fill tube.

11. The process of claim 9, wherein the rim included in the spud has a cylindrical shape.

12. The process of claim 9, wherein the spud-retainer sleeve includes an inner cylinder-shaped tube cantilevered to the annular jacket and arranged to surround the tubular housing and an outer cylinder-shaped tube cantilevered to the annular jacket and arranged to surround the inner cylinder-shaped tube to define the rim-receiving channel therebetween, and the rim is cylinder-shaped and arranged to lie in the rim-receiving channel between the inner and outer cylinder-shaped tubes of the spud-retainer sleeve.

13. The process of claim 1, wherein the coupling step comprises the steps of passing the upstream end of the tubular housing through a central channel formed in the spud until the spud mates with the spud anchor and fastening the spud anchor to the spud to create a mechanical joint and a fluid-leak barrier between the spud and the spud anchor.

14. The process of claim 13, wherein the coupling step further comprises the steps of inserting the downstream end of the tubular housing carrying the inlet check valve apparatus into the interior fuel-storage region of the fuel tank through the inlet aperture formed in the fuel tank and fastening the spud to the fuel tank to retain the tubular housing in a fixed position relative to the fuel tank.

15. The process of claim 14, further comprising the step of coupling the fill tube to the spud to cause a fuel-conducting passageway formed in the fill tube to lie in fluid communication with the fuel-transfer channel formed in the tubular housing to communicate with the interior fuel-storage region in the fuel tank when a closure included in the inlet check valve apparatus is moved relative to the tubular housing from a closed position blocking a downstream fuel-discharge aperture formed in the downstream end of the tubular housing to an opened position opening the downstream fuel-discharge aperture formed in the downstream end of the tubular housing.

16. The process of claim 1, wherein after the overmolding step the ring-shaped spud anchor is located on and arranged to surround a middle portion of the tubular housing midway between the upstream and downstream ends of the tubular housing.

17. A process of assembling a portion of a fuel tank filler neck, the process comprising the steps of
providing a tubular housing formed to include a fuel-transfer channel extending from a downstream end thereof to an upstream end thereof,
mounting an inlet check valve apparatus on the downstream end of the tubular housing to regulate flow of liquid fuel and fuel vapor through an outlet formed in the tubular housing to open into the fuel-transfer channel, and
overmolding a ring-shaped spud anchor included in a tank mount onto an exterior portion of the tubular housing to locate the ring-shaped spud anchor in a stationary position on the tubular housing to be coupled to a fill-tube connector spud also included in the tank mount and arranged to be coupled to the fuel tank and a fill tube associated with the fuel tank

18. The process of claim 17, wherein the tubular housing includes a pipe formed to include the fuel-transfer channel and a radially outwardly extending anchor retainer coupled to an exterior portion of the pipe and embedded in the spud anchor during the overmolding step to retain the spud anchor in the stationary position on the tubular housing.

19. The process of claim 18, wherein the anchor retainer includes a radially outwardly extending first lobe located between the downstream and upstream ends of the tubular housing and a radially outwardly extending second lobe located between the first lobe and the upstream end.

20. The process of claim 18, wherein the spud anchor includes an annular jacket overmolded onto the pipe and to the anchor retainer and a spud-retainer sleeve coupled to the annular jacket and arranged to extend along an exterior surface of the pipe in a direction toward the upstream end of the tubular housing and the spud is coupled to the spud-retainer sleeve.

21. The process of claim 20, wherein the spud-retainer sleeve is formed to include a rim-receiving channel and the fill-tube connector spud includes a rim that is arranged to extend into the rim-receiving channel to couple the fill-tube connector spud to the spud anchor.

22. The process of claim 21, wherein the spud further includes a tank-mount pad arranged to surround the rim and mate with the fuel tank and a tank-mount shaft arranged to extend along and around the pipe of the tubular housing and mate with the fill tube.

23. A fuel system comprising
a fuel tank filler neck including a fuel conductor adapted to extend into an interior fuel-storage region formed in a fuel tank through an inlet aperture formed in the fuel tank and to mate with a fill tube formed to include a fuel-conducting passageway, wherein the fuel conductor includes
a tubular housing formed to include downstream and upstream ends and a full-transfer channel extending from the downstream end to the upstream end and made of a first material,
an inlet check valve apparatus including a closure mounted for movement relative to the downstream end of the tubular housing to open and close a downstream fuel-discharge aperture opening into the fuel-transfer channel and being adopted to communicate with the interior fuel-storage region of the fuel tank, and
a tank mount including a stationary spud anchor, wherein the stationary spud anchor is made of a second material different from the first material and configured to provide means for mating with a spud coupled to the fuel tank to fix the tubular housing in a stationary position extending through the inlet aperture formed in the fuel tank and locating the inlet check valve apparatus in the interior fuel-storage region of the fuel tank.

24. The fuel system of claim 23, wherein the tubular housing includes a pipe formed to include the fuel-transfer channel and a radially outwardly extending anchor retainer coupled to an exterior portion of the pipe and embedded in the spud anchor to retain the spud anchor in the stationary position on the tubular housing.

25. The fuel system of claim 24, wherein the anchor retainer includes a radially outwardly extending first lobe located between the upstream and downstream ends of the tubular housing and a radially outwardly extending second lobe located between the first lobe and the upstream end.

26. The fuel system of claim 25, wherein the first lobe is ring-shaped and has a first outer diameter and the second lobe is ring-shaped and has a second outer diameter that is greater than the first outer diameter.

27. The fuel system of claim 23, wherein the tank mount further includes a fill-tube connector spud formed to include a central channel and fill-tube connector spud is coupled to the stationary spud anchor to cause the upstream end of the tubular housing to extend into the central channel of the fill-tube connector spud and is adapted to mate with the fill tube to place the fuel-conducting passageway formed in the fill tube and the fuel-transfer channel formed in the tubular housing in fluid communication with one another.

28. The fuel system of claim 27, wherein the spud anchor includes an annular jacket overmolded onto the pipe and to the first and second lobes and a spud-retainer sleeve coupled to the annular jacket and arranged to extend along an exterior surface of the pipe in a direction toward the inlet end of the tubular housing and the fill-tube connector spud is coupled to the spud-retainer sleeve.

29. The fuel system of claim 28, wherein the annular jacket is located in the interior fuel-storage region of the fuel tank and the spud-retainer sleeve is arranged to extend through the inlet aperture formed in the fuel tank.

30. The fuel system of claim 28, wherein the annular jacket is located in the interior fuel-storage region of the fuel tank and the spud-retainer sleeve is arranged to extend through the inlet aperture formed in the fuel tank.

31. The fuel system of claim 28, wherein the spud-retainer sleeve is formed to include a rim-receiving channel and the spud includes a rim that is arranged to extend into the rim-receiving channel to couple the fill-tube connector spud to the spud anchor.

32. The fuel system of claim 31, wherein the fill-tube connector spud further includes a tank-mount pad arranged to surround the rim and mate with the fuel tank and a tank-mount shaft arranged to extend along and around the pipe of the tubular housing and mate with the fill tube.

33. The fuel system of claim 32, wherein the rim included in the spud has a cylindrical shape.

34. The fuel system of claim 31, wherein the spud-retainer sleeve includes an inner cylinder-shaped tube cantilevered to the annular jacket and arranged to surround the tubular housing and an outer cylinder-shaped tube cantilevered to the annular jacket and arranged to surround the inner cylinder-shaped tube to define the rim-receiving channel therebetween, and the rim is cylinder-shaped and arranged to lie in the rim-receiving channel between the inner and outer cylinder-shaped tubes of the spud-retainer sleeve.
